(19) United States
(12) Patent Application Publication
(10) Pub. No.: US 2025/0017332 A1
(43) Pub. Date: Jan. 16, 2025

(54) BAND AND WATCH

(71) Applicant: CASIO COMPUTER CO., LTD., Tokyo (JP)

(72) Inventors: Kazuyuki TANABE, Tokyo (JP); Masao AMANO, Tokyo (JP)

(21) Appl. No.: 18/768,945

(22) Filed: Jul. 10, 2024

(30) Foreign Application Priority Data
Jul. 11, 2023 (JP) 2023-113376

(51) Int. Cl. A44C 5/14

(52) U.S. Cl. CPC A44C 5/14

(57) ABSTRACT

A band for mounting to a main body case is shown. The band includes, a band main body formed of a resin material; and an insert part disposed in the band main body on a side which is to be mounted to the main body case. The insert part is entirely covered with the resin material of the band main body.

### REFERENCE TO RELATED APPLICATIONS

This application is based upon and claims the benefit of priority from the prior Japanese Patent Application No. 2023-113376, filed on Jul. 11, 2023, the entire contents of which are incorporated herein by reference.

### BACKGROUND OF THE INVENTION

### Field of the Invention

The present invention relates to a band and a watch.

### Description of the Related Art

Japanese Unexamined Utility Model Application Publication No. S63-140212 describes a watch band in which a lug member formed of a material harder than resin material is inserted into one end of a watch band made of resin (urethane), so that a mounting portion (tip lug portion) that is to be mounted to a main body case is made thin but strong.

### SUMMARY

In order to solve the above problem, a band according to the present invention is a band for mounting to a main body case, the band including: a band main body formed of a resin material; and an insert part disposed in the band main body on a side which is to be mounted to the main body case, wherein the insert part is entirely covered with the resin material of the band main body.

### BRIEF DESCRIPTION OF THE DRAWINGS

FIG. 1 is a schematic plan view of a watch according to the first embodiment.

FIG. 2 is a plan view of the main part viewed from a front surface side of a band around a mounting portion of the band that is to be mounted to a main body case according to the first embodiment.

FIG. 3 is a plan view of the main part viewed from a back surface side of the band around the mounting portion of the band that is to be mounted to the main body case according to the first embodiment.

FIG. 4 is a side view of the main part around the mounting portion of the band that is to be mounted to the main body case according to the first embodiment.

FIG. 5 is a perspective view of the main part viewed from the front surface side of the band around the mounting portion of the band that is to be mounted to the main body case according to the first embodiment.

FIG. 6 is an enlarged view of a VI portion surrounded by a dashed and dotted line in FIG. 2.

FIG. 7 is an enlarged view of a VII portion surrounded by a dashed and dotted line in FIG. 4.

FIG. 8 is an enlarged view of a VIII portion surrounded by a dashed and dotted line in FIG. 5.

FIG. 9 is a plan view of the main part viewed from the front surface side of the band around the mounting portion of the band that is to be mounted to the main body case according to the second embodiment.

FIG. 10 is a plan view of the main part viewed from the back surface side of the band around the mounting portion of the band that is to be mounted to the main body case according to the second embodiment.

FIG. 11 is a side view of the main part around the mounting portion of the band that is to be mounted to the main body case according to the second embodiment.

FIG. 12 is an enlarged view of a XII portion surrounded by a dashed and dotted line in FIG. 9.

FIG. 13 is an enlarged view of a XIII portion surrounded by a dashed and dotted line in FIG. 11.

FIG. 14 is a plan view of the main part viewed from the front surface side of the band around the mounting portion of the band that is to be mounted to the main body case according to the third embodiment.

FIG. 15 is a plan view of the main part viewed from the back surface side of the band around the mounting portion of the band that is to be mounted to the main body case according to the third embodiment.

FIG. 16 is a side view of the main part around the mounting portion of the band that is to be mounted to the main body case according to the third embodiment.

FIG. 17 is a perspective view of the main part viewed from the surface side of the band around the mounting portion of the band that is to be mounted to the main body case according to the third embodiment.

FIG. 18 is an enlarged view of a XVIII portion surrounded by a dashed and dotted line in FIG. 14.

FIG. 19 is an enlarged view of a IXX portion surrounded by a dashed and dotted line in FIG. 16.

FIG. 20 is an enlarged view of a XX portion surrounded by a dashed and dotted line in FIG. 17.

### DETAILED DESCRIPTION OF THE PREFERRED EMBODIMENTS

### First Embodiment

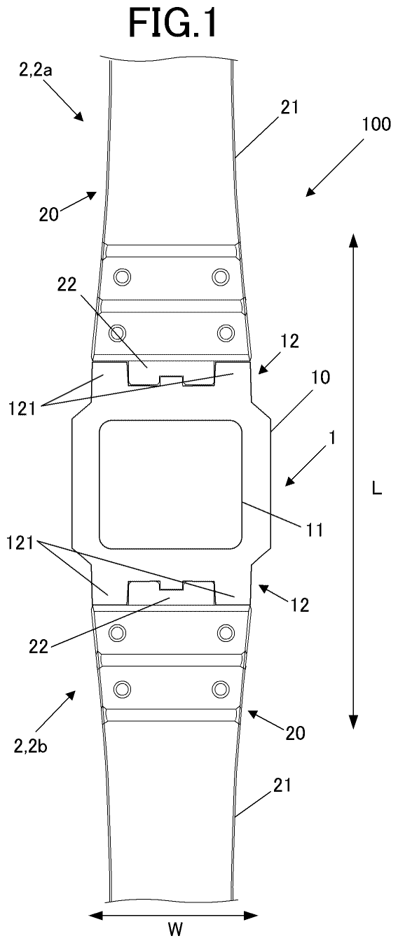

With reference to FIG. 1 to FIG. 8, the first embodiment of a band and watch according to the present invention will be described.

In the first embodiment described below, a case where the band is provided on a wristwatch (hereinafter referred to as “watch 100”) worn on the wrist will be described as an example. Various limitations that are technically preferable to implement the present disclosure are added to the first embodiment described below. However, the scope of the present disclosure is not limited to the first embodiment and the illustrated examples described below.

### [Configuration]

FIG. 1 is a schematic plan view of a watch including a band according to the first embodiment.

As shown in FIG. 1, the watch 100 of the first embodiment includes a watch main body 1 and a band 2 connected to the main body case 10 of the watch main body 1.

First, the main body case 10 constituting the watch main body 1 is formed in a hollow short column shape.

The material for forming the main body case 10 is not particularly limited, but is made of, for example, a hard synthetic resin such as a super engineering plastic such as polyarylate (PAR) or an engineering plastic such as polyacetal (POM), or a hard material such as various metals such as titanium and stainless steel (SUS).

Japanese Unexamined Utility Model Application Publication No. S63-140212 describes a watch band in which a lug member formed of a material harder than resin material is inserted into one end of a watch band made of resin (urethane), so that a mounting portion (tip lug portion) that is to be mounted to a main body case is made thin but strong.

In such band formed from various resin, when inserting a part formed of a material harder than the resin material (referred to as an “insert part”) or the like at the end of the main body section, it is necessary to firmly bond the insert part and the resin material constituting the main body of the band.

However, there is a problem that adhesion between the resin material and the insert part formed of a material harder than the resin material is poor, and it is difficult to firmly bond the above material.

The present invention is intended to improve and solve the problems of such situations, and the resin band can be firmly fixed to the main body case.

Although not shown, a watch module is accommodated in a hollow portion in the main body case 10. The watch module includes various components necessary for a function to count time, for example, a mechanical movement including an analog display mechanism that carries a pointer and a digital display mechanism including a liquid crystal display unit, and the like, and a circuit unit that controls driving thereof. Further, a display 11 for displaying the time and various information is provided on a front surface of the main body case 10. Further, an operator such as a crown and a push button (not shown) is provided on the side or the like of the main body case 10.

FIG. 1 schematically illustrates the watch main body 1, and does not accurately indicate a specific shape, configuration, or the like.

As shown in FIG. 1, a band mounting section 12 for connecting the band 2 to the main body case 10 is provided at positions which are on an outer side of the main body case 10 and which correspond to a 6 o'clock side and a 12 o'clock side in an analog watch.

In the illustrated example, the band mounting section 12 has a shape in which a lug 121 protrudes from both sides in a width direction of the main body case 10, and a mounting section 22 of the band 2 is fitted between the lugs 121. The shape of the band mounting section 12 is not limited to the illustrated example. The band 2 is provided with a mounting section 22 that matches the shape of the band mounting section 12.

As shown in FIG. 1, the band 2 is a band attached to the main body case 10, and includes a parent band (short band) 2a attached to the band mounting section 12 on the 12 o'clock side in the analog watch, and a sword tip band (long band) 2b attached to the band mounting section 12 on the 6 o'clock side.

Since the configuration of the mounting section 22 that is to be mounted to the main body case 10 of the parent band 2a and the sword tip band 2b is the same, the parent band 2a and the sword tip band 2b are not distinguished hereinafter, but are simply referred to as “band 2”.

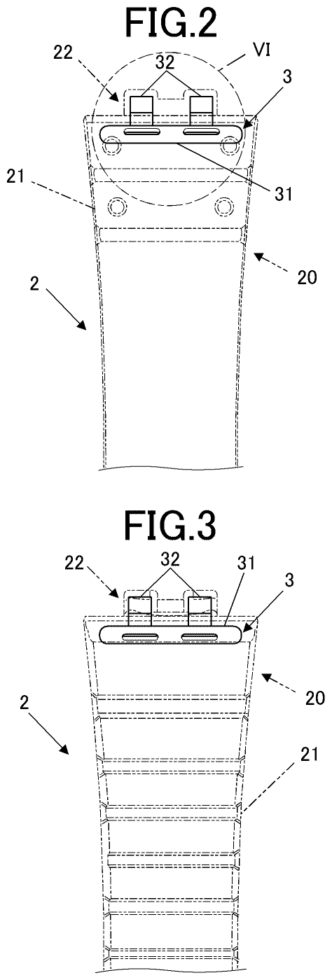

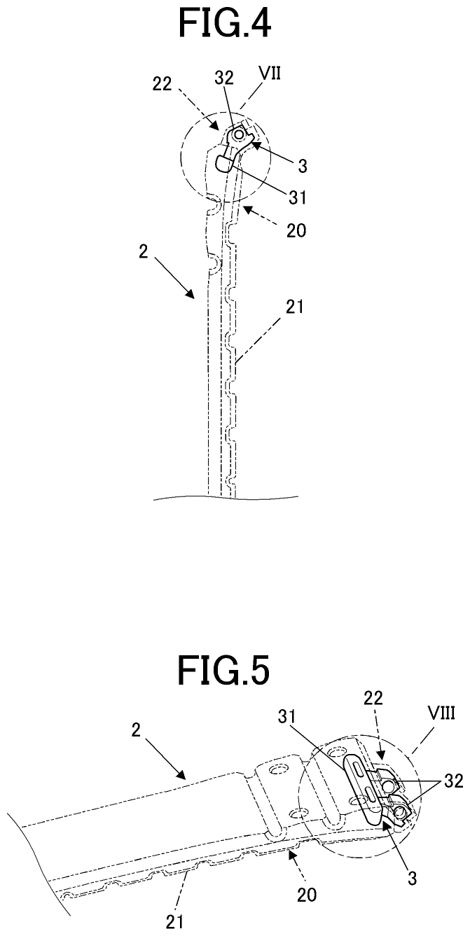

FIG. 2 is a plan view of the main part viewed from the front surface side of the band around the mounting portion of the band that is to be mounted to the main body case according to the first embodiment, and FIG. 3 is a plan view of the main part viewed from the back surface side of the band around the mounting portion of the band that is to be mounted to the main body case according to the first embodiment. FIG. 4 is a side view of the main part around the mounting portion of the band that is to be mounted to the main body case according to the first embodiment, and FIG. 5 is a perspective view of the main part viewed from the front surface side of the band around the mounting portion of the band that is to be mounted to the main body case according to the first embodiment. In FIG. 2 and later, the band main body 20 described later in the band 2 is shown by a dashed and two-dotted line, and the insert part 3 is shown by a solid line.

As shown in FIG. 2 to FIG. 5, the band 2 includes a band main body 20 and an insert part 3.

The band main body 20 is formed of a resin material. As the resin material forming the band main body 20, for example, a relatively soft synthetic resin such as fluorine rubber (a resin having rubber elasticity composed of a fluororesin), an urethane resin, or a silicone resin is applied. Note that the material for forming the band main body 20 is not limited to those exemplified herein.

The band main body 20 includes a main body section 21 that is a band-shaped portion formed long in the longitudinal direction L (see FIG. 1) of the band 2, and a mounting section 22 mounted to the band mounting section 12 of the main body case 10.

The insert part 3 is a member disposed on the mounting side with respect to the main body case 10 in the band main body 20 (the side attached to the band mounting section 12). The insert part 3 is formed by cutting various metal materials such as titanium and stainless steel (SUS), for example, and is a part having strength and rigidity. The material for forming the insert part 3 is not limited to the metal material. Various hard materials with sufficient strength and rigidity like metal may be applied. Further, the method for forming the insert part 3 is not limited to cutting processing, and various methods can be used. For example, the insert part 3 may be formed using a 3D printer or the like.

When the band 2 is molded, the insert part is disposed on the mounting section 22 side of the resin material forming the band main body 20 and is insert molded.

As shown in FIG. 2 to FIG. 5 and the like, the insert part 3 includes a main body 31 and a connector 32.

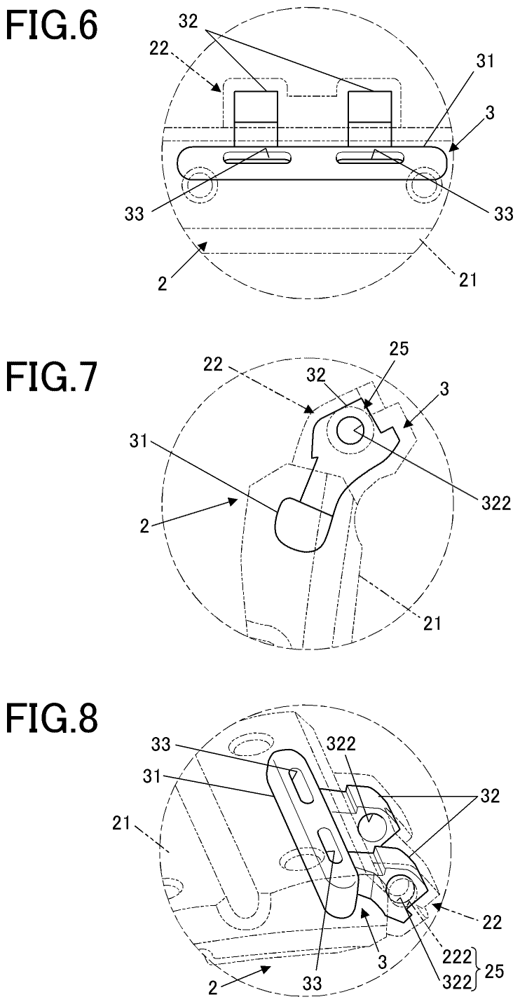

The main body 31 is a long part in a width direction W of the band 2 (see FIG. 1). In the main body 31, when the front surface side of the band 2 is viewed as a plane, a plurality of filling holes 33 (see FIG. 6, etc.) are formed. The filling hole 33 (first hole) is a hole filled with a resin material that forms the band main body 20 during insert molding.

In the first embodiment, the filling hole 33 is a long hole in which the length in the width direction W of the band 2 (see FIG. 1) is longer than the length in the longitudinal direction L of the band 2. As shown in FIG. 2 and FIG. 3, the filling hole 33 penetrates the front and back of the main body 31 of the insert part 3.

Two filling holes 33 shown in the first embodiment are arranged side by side in the width direction W of the band 2. The number and arrangement of the filling holes 33 are not limited to the illustrated examples. For example, three or more filling holes 33 may be arranged side by side in the width direction W of band 2. In this case, the length of each filling hole 33 may be shorter than in the case of two holes. Further, the width of the longitudinal direction L of the band 2 in the main body 31 may be increased, and the filling holes 33 may be arranged in a plurality of parallel arrangements in the longitudinal direction L of the band 2. Further, a plurality of filling holes 33 may be disposed in the width direction W of the band 2 and the longitudinal direction L of the band 2, for example, two in the width direction W of the band 2, two in the longitudinal direction L of the band 2, and a total of four may be arranged. Thus, when a plurality of filling holes 33 are provided in the width direction W of the band 2 and the longitudinal direction L of the band 2, the filling hole 33 may be arranged in a staggered manner by, for example, shifting the positions in the longitudinal direction L of the band 2.

FIG. 6 is an enlarged view of the VI portion in FIG. 2.

As shown in FIG. 1, FIG. 2 and FIG. 6, the connector 32 is formed protruding from the main body 31 toward the mounting side that is to be mounted to the main body case 10.

As shown in FIG. 2 to FIG. 5, etc., in the first embodiment, two connectors 32 are provided.

FIG. 7 is an enlarged view of the VII portion in FIG. 4, and FIG. 8 is an enlarged view of the VIII portion in FIG. 5.

As shown in FIG. 4, FIG. 5, FIG. 7 and FIG. 8, each connector 32 has an axial hole 322 that penetrates the width direction W (see FIG. 1) of the band 2 (see FIG. 5 and FIG. 8).

In particular, as shown in FIG. 7 and FIG. 8, the insert part 3 including the main body 31 and the connector 32 is entirely covered with the resin material of the band main body 20 in insert molding.

As shown in FIG. 8, a through hole 222 is formed at a position corresponding to a shaft hole 322 of the connector 32 in the mounting section 22 of the band main body 20. Even in insert molding, the through hole 222 and the shaft hole 322 are communicated without being blocked by the resin material. A penetrating section 25 that penetrates with the through hole 222 and the shaft hole 322 in the width direction W of the band 2 (see FIG. 1) is formed in the mounting section 22 of the band 2, which is an insert molded product.

When mounting the mounting section 22 to the band mounting section 12 of the main body case 10, a spring bar or the like (not shown) is inserted into the penetrating section 25, thereby latching the mounting section 22 of the band 2 to the band mounting section 12.

### [Operation]

Next, the operation of the band 2 and the watch 100 including the band 2 according to the first embodiment will be described.

When forming the band 2, the insert part 3 is placed on the side corresponding to the mounting section 22 of the band 2, which is an insert molded product, in the insert molding mold, and a resin material (for example, fluorine rubber, etc.) constituting the band main body 20 is injected around it. With this, insert molding to mold as one (composite molding) is performed. At this time, the filling hole 33 of the insert part 3 is filled with a resin material.

The band 2 thus formed has a penetration portion 25 in the mounting section 22.

When attaching the band 2 to the watch main body 1, the mounting section 22 of the band 2 is fitted to the band mounting section 12 of the main body case 10 of the watch main body 1, and a spring bar or the like is inserted into the penetration portion 25. As a result, the band 2 is latched to the main body case 10.

The side in the band 2 that is to be mounted to the main body case 10 is repeatedly subjected to a pulling force and a torsional force not only when attaching and detaching the band 2 but also when the watch 100 is attached to the arm and used. This becomes a heavy burden to the side in the band 2 mounted to the main body case 10.

In this regard, in the band main body 20, an insert part 3 formed of a metal material or the like is disposed inside the mounting side of the band 2 including the mounting section 22 attached to the band mounting section 12 of the main body case 10. As a result, the mounting section 22 is reinforced, resistant to deformation due to external force, and can withstand repeated loads.

The insert part 3 is entirely covered with a resin material, and a filling hole 33 is provided in the main body 31 of the insert part 3 so as to penetrate from the front surface side to the back surface side. The resin material to mold the band main body 20 is filled in the filling hole 33. For this reason, the resin material becomes entangled with the insert part 3, is firmly integrated, and the band 2 is difficult to be damaged.

### Effects

As described above, the band 2 in the first embodiment is the band 2 attached to the main body case 10, and includes the band main body 20 formed of a resin material and the insert part 3 disposed on the mounting side with respect to the main body case 10 in the band main body 20. The insert part 3 is entirely covered with the resin material of the band main body 20.

Thereby, the resin material for molding the band main body 20 and the insert part 3 such as a metal as a reinforcing member can be firmly integrated. For this reason, even if the user pulls the band 2 strongly, the band 2 does not break or the like, the band 2 is resistant to deformation due to external force, and the band 2 can be made to have high rigidity and durability.

Further, the insert part 3 of the first embodiment has a plurality of filling holes 33 as holes in which the resin material (for example, fluorine rubber, etc.) of the band main body 20 is filled at the time of insert molding.

As a result, the resin material is entangled with the insert part 3, and in the band 2 as an insert molded product, the band main body 20 formed of the resin material and the insert part 3 formed of the metal material are firmly integrated. For this reason, the band 2 is resistant to deformation due to pulling force and external force, and the band 2 can be given high rigidity and durability.

The filling hole 33 which is the hole according to the first embodiment is a long hole in which the length in the width direction W of the band 2 (see FIG. 1) is longer than the length in the longitudinal direction L of the band 2.

For this reason, the main body 31, which is the portion in which the filling hole 33 is formed, can be rod-shaped with the length in the width direction W of the band 2 being longer than the length in the longitudinal direction L of the band 2, as shown in FIG. 6. Thereby, while improving the strength of the mounting side of the band 2, the part where the insert part 3 is disposed inside can be kept within a narrow range on the mounting side that is to be mounted to the main body case 10. For this reason, it is possible to realize a band 2 that is comfortable on the arm and familiar to the arm without impairing the wearing comfort of the resin band 2 formed of a relatively soft resin material such as fluorine rubber.

Then, when such a band 2 is attached to the main body case 10 of the watch main body 1 to form the watch 100, the watch 100 having excellent wearing comfort and excellent durability of the band 2 can be realized.

The first embodiment according to the present invention is described above but the present invention is not limited to the above-described first embodiment, and various modifications are possible without leaving the scope of the present disclosure.

For example, the shape of the insert part is not limited to that exemplified in FIG. 2 to FIG. 5, and can be appropriately changed.

### Second Embodiment

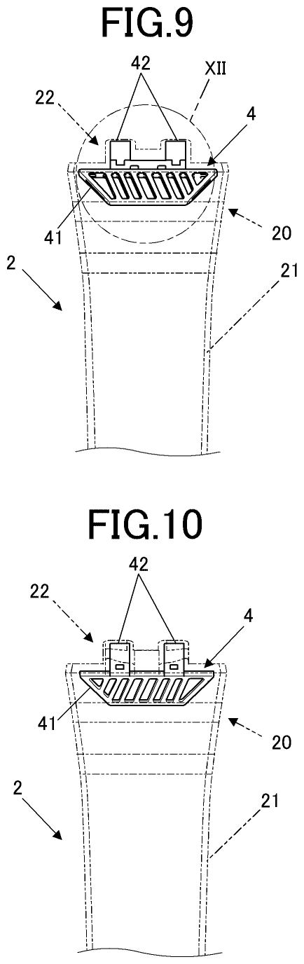

FIG. 9 to FIG. 13 show an example in which the insert part according to the second embodiment is incorporated into the band 2.

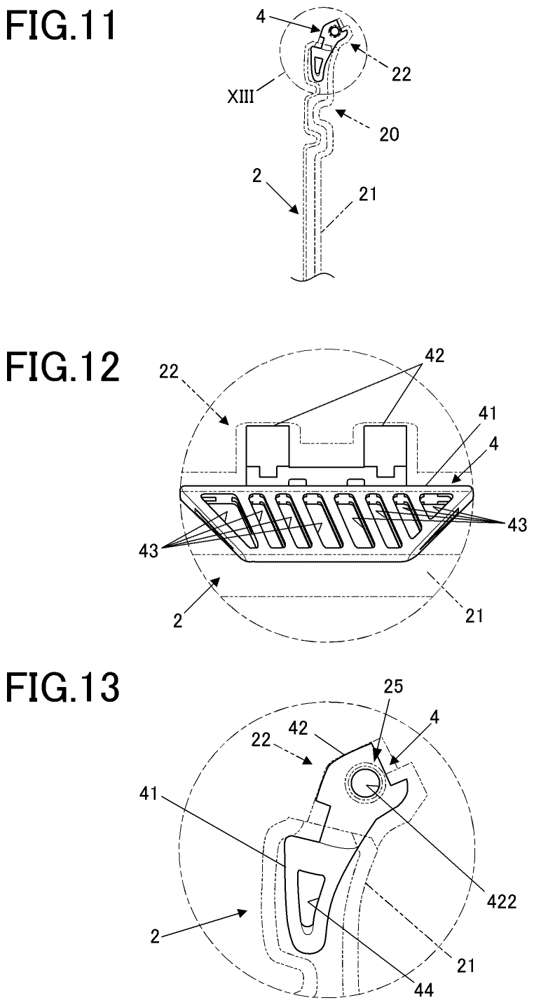

FIG. 9 is a plan view of the main part viewed from the front surface side of the band around the mounting portion of the band that is to be mounted to the main body case according to the second embodiment, and FIG. 10 is a plan view of the main part viewed from the back surface side of the band around the mounting portion of the band that is to be mounted to the main body case according to the second embodiment. FIG. 11 is a side view of the main part around the mounting portion of the band that is to be mounted to the main body case according to the second embodiment. In FIG. 9 to FIG. 13 also, the band main body 20 in the band 2 is shown by a dashed and two-dotted line, and the insert part 4 is shown by a solid line. Since the band 2 shown in FIG. 9 to FIG. 13 is the same as in the embodiment except for the insert part 4, the same part is denoted by the same reference numerals and the description thereof is omitted.

As shown in FIG. 9 and FIG. 10, the insert part 4 according to the second embodiment is formed long in the width direction W (see FIG. 1) of the band 2 and includes a main body 41 and a connector 42.

The main body 41 has a substantially inverted trapezoidal shape in a flat view, particularly having a long side on the mounting side that is to be mounted to the main body case 10. Further, the connector 42 is formed protruding toward the mounting side (side of a long side of the inverted trapezoid) that is to be mounted to the main body case 10 in the main body 41.

The insert part 4 is formed using a 3D printer (3D printer for metal) using various metal materials such as titanium and stainless steel (SUS), for example. The material for forming the insert part 4 is not limited to metal, and various hard materials having sufficient strength and rigidity similar to metals may be applied. Further, the method for forming the insert part 4 is not limited to a 3D printer, and other methods may be used.

The shape of the connector 42 is the same as that of the connector 32 in the first embodiment.

FIG. 12 is an enlarged view of the XII portion in FIG. 9, and FIG. 13 is an enlarged view of the XIII portion in FIG. 11.

As shown in FIG. 11 and FIG. 13, the shaft hole 422 is formed in the connector 42 at the same position as the shaft hole 322 in the connector 32.

Further, as shown in FIG. 12, a plurality of filling holes 43 (first holes) are formed in the main body 41 of the insert part 4.

In the second embodiment shown in FIG. 9, FIG. 10, and FIG. 12, the filling hole 43 is a long hole in which the length in the longitudinal direction L of the band 2 (see FIG. 1) is longer than the length in the width direction W of the band 2. In the illustrated example, a plurality of slit-like holes with narrow widths are provided side by side. As shown in FIG. 9 and FIG. 10, the filling hole 43 penetrates the front and back of the main body 41 of the insert part 4.

The shape, arrangement, and the like of the filling hole 43 are not limited to the illustrated example. For example, the filling hole 43 may be a hole of a wide width in the width direction W of the band 2. In this case, for example, two filling holes 43 may be provided side by side in the width direction W of the band 2. In the illustrated example, the filling hole 43 is provided at a slight angle to the longitudinal direction of the band 2, but for example, the filling hole 43 may be provided parallel to the longitudinal direction L of the band 2.

Further, as shown in FIG. 11 and FIG. 13, a filling hole 44 is also formed on the side of the insert part 4. The filling hole 44 (second hole) on the side is penetrated in the width direction of the main body 41 in the same way as the shaft hole 422.

As shown in FIG. 9 to FIG. 13, when the insert part 4 is provided in the band 2, the insert part 4 including the main body 41 and the connector 42 is entirely covered with the resin material of the band main body 20 in insert molding. The resin material is inserted in the filling holes 43 and 44 from the vertical direction (front and back direction of the band 2) and the horizontal direction (width direction W of the band 2). With this, the band 2 is sufficiently entangled with the insert part 4.

As a result, the resin material constituting the band main body 20 is firmly integrated with the insert part 4, and even if the band 2 is strongly pulled, the band 2 does not break or the like, the band 2 is resistant to deformation due to external force, and the band 2 can be given high rigidity and durability.

### Third Embodiment

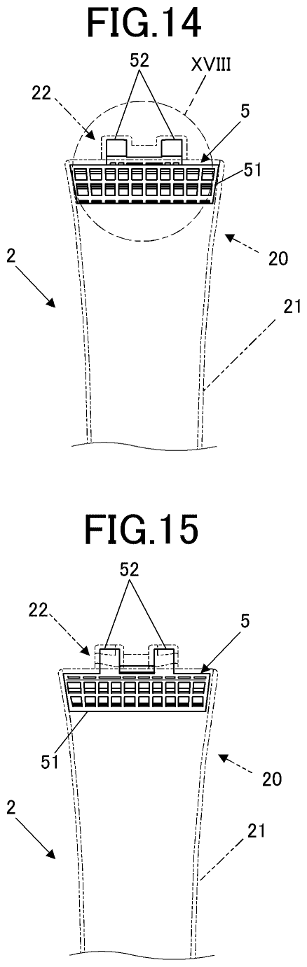

FIG. 14 to FIG. 20 show an example in which the insert part according to the third embodiment is incorporated into the band 2.

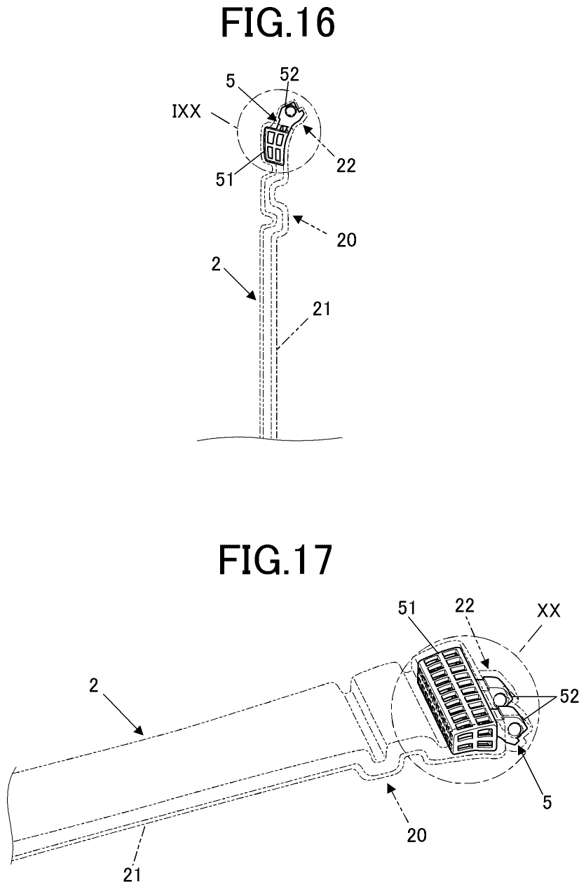

FIG. 14 is a plan view of the main part viewed from the front surface side of the band around the mounting portion of the band that is to be mounted to the main body case according to the third embodiment, FIG. 15 is a plan view of the main part viewed from the back surface side of the band around the mounting portion of the band that is to be mounted to the main body case according to the third embodiment, and FIG. 16 is a side view of the main part around the mounting portion of the band that is to be mounted to the main body case according to the third embodiment, and FIG. 17 is a perspective view of the main part viewed from the surface side of the band around the mounting portion of the band that is to be mounted to the main body case according to the third embodiment. In FIG. 14 to FIG. 20 also, the band main body 20 in the band 2 is shown by a dashed and two-dotted line, and the insert part 5 is shown by a solid line. Since the band 2 shown in FIG. 14 to FIG. 20 is the same as in the first embodiment except for the insert part 5, the same part is denoted by the same reference numerals and the description thereof is omitted.

As shown in FIG. 14 and FIG. 15, the insert part 5 according to the third embodiment is formed long in the width direction W (see FIG. 1) of the band 2 and includes a main body 51 and a connector 52.

The shape of the connector 52 is the same as that of the connector 32 in the first embodiment.

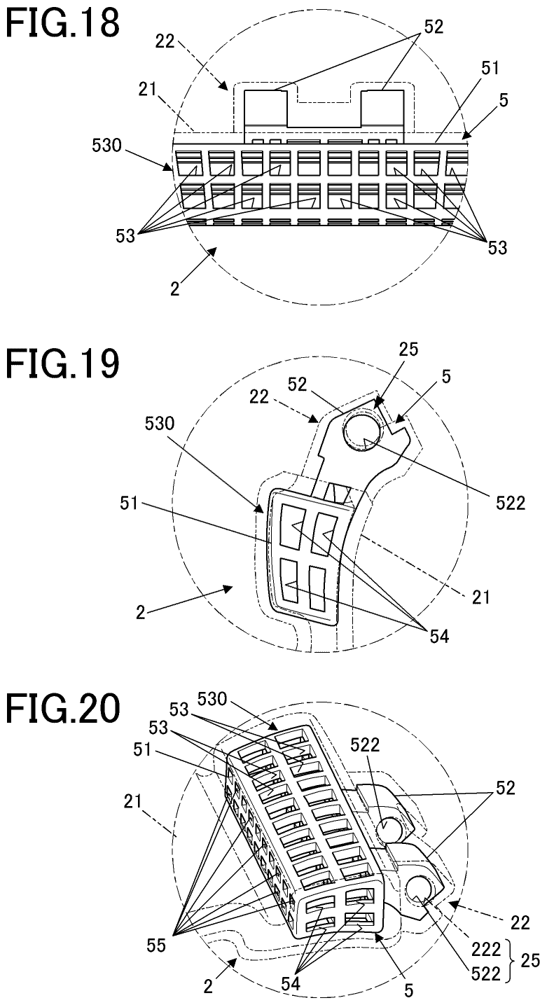

FIG. 18 is an enlarged view of the XVIII portion in FIG. 14, FIG. 19 is an enlarged view of the IXX portion in FIG. 16, and FIG. 20 is an enlarged view of the XX portion in FIG. 17.

As shown in FIG. 16 and FIG. 19, the shaft hole 522 is formed in the connector 52 at the same positions as the shaft hole 322 in the connector 32 and the shaft hole 422 in the connector 42.

The insert part 5 is formed using various metal materials such as titanium and stainless steel (SUS), for example, and using a 3D printer (3D printer for metal) or the like in the same manner as the insert part 4. The material for forming the insert part 5 is not limited to metal, and various hard materials having sufficient strength and rigidity similar to metals may be applied. Further, the method for forming the insert part 5 is not limited to a 3D printer, and other methods may be used.

Further, as shown in FIG. 18, FIG. 19, and FIG. 20, a plurality of filling holes 53, 54, and 55 are formed in the main body 51 of the insert part 5. Specifically, a plurality of filling holes 53 (first holes) are formed in the main body 51 of the insert part 5 when the band 2 is viewed as a plane. Next, a plurality of filling holes 54 (second holes) are formed in the main body 51 of the insert part 5 when the band 2 is viewed from one side. Next, a plurality of filling holes 55 (third holes) are formed in the main body 51 of the insert part 5 when the band 2 is viewed from the side in another direction perpendicular to the above-described one side.

That is, according to the third embodiment shown in FIG. 14 to FIG. 20, the main body 51 of the insert part 5 has a hollow structure portion 530 formed in a lattice shape in the width direction W of the band 2 and the longitudinal direction L of the band 2 (see FIG. 1). The hollow structure portion 530 includes filling holes 53, 54, and 55 which are holes in which resin material composing the band main body 20 is filled in insert molding.

The hollow structure portion 530 is a hollow structure formed by a plurality of three-dimensional lattice-shaped unit bodies being repeated continuously, and has a so-called lattice structure. The shape of the lattice of the lattice structure is not limited to the illustrated example.

As shown in FIG. 18, FIG. 19, FIG. 20, and the like, the main body 51 is penetrated by the filling hole 53 in the vertical direction (up and down, front and back direction) of the band 2, the filling hole 54 in the horizontal direction (width direction W of the band 2), and the filling hole 55 in the length direction (longitudinal direction L of the band 2).

As a result, when the insert part 5 is provided in the band 2, when the insert part 5 including the main body 51 and the connector 52 is entirely covered with the resin material of the band main body 20 in insert molding, the resin material enters the filling holes 53, 54, and 55 from the vertical direction (front and back direction of the band 2), the horizontal direction (width direction W of the band 2) and the length direction (longitudinal direction L of the band 2). With this, the band 2 is sufficiently entangled with the insert part 5.

As a result, the resin material constituting the band main body 20 is firmly integrated with the insert part 5, and even if the band 2 is strongly pulled, the band 2 does not break or the like, the band 2 is resistant to deformation due to external force, and the band 2 can be given high rigidity and durability.

Thus, when the lattice structure is incorporated into the insert part 5 (particularly the hollow structure portion 530 of the main body 51), the band 2 is a hollow structure, so that the insert part 5 can be reduced in weight compared to the solid structure. Moreover, the amount of necessary material can be reduced. Moreover, since a plurality of continuously repeated lattice structures are packed in the hollow structure portion 530, high rigidity can be realized while reducing weight.

In addition, the filling holes 33 (first hole), 43 (first hole), 44 (second hole), 53 (first hole), 54 (second hole), and 55 (third hole) as holes provided in the main bodies 31, 41, and 51 of the insert parts 3, 4, and 5 shown in the first to third embodiments are all cases of through holes. However, some or all of the filling holes 33, 43, 44, 53, 54, and 55 may include a non-penetrating recess or the like. Even if some or all of the filling holes 33, 43, 44, 53, 54, and 55 of the insert parts 3, 4, and 5 are recessed, the resin material constituting the band main body 20 is entangled with the insert parts 3, 4, and 5 at the time of insert molding. Therefore, it is possible to expect that the insert parts 3, 4, and 5 are integrated with the band main body 20.

In the first to third embodiments, various hard materials having sufficient strength and rigidity similar to metals are mentioned as the materials for forming the insert parts 3, 4, and 5. However, it is not limited to this configuration. The material constituting the insert parts 3, 4, and 5 may be a material that is harder than the resin material constituting the band main body 20.

Further, in the present embodiment, an example in which the band 2 is connected to the main body case 10 of the watch 100 has been described, but the band 2 is not limited to the band 2 for the watch attached to the main body case 10 of the watch 100.

For example, it is possible to apply the band 2 of the present invention as a band connected to the main body case of various devices (for example, smart watches, pedometers, heart rate monitors, etc.) fixed to the body by the band 2.

Although some embodiments of the present invention have been described above, the scope of the present invention is not limited to the above-described embodiments. The specific configuration, structure, positional relationship, and the like shown in the first, second, and third embodiments described above can be suitably changed without leaving the scope of the present invention. The scope of the present invention includes the scope of the claims and their equivalents.

1. A band for mounting to a main body case, the band comprising:
a band main body formed of a resin material; and
an insert part disposed in the band main body on a side which is to be mounted to the main body case,
wherein the insert part is entirely covered with the resin material of the band main body.

2. The band according to claim 1, wherein the insert part is formed with a plurality of first holes filled with the resin material of the band main body in insert molding.

3. The band according to claim 2, wherein the first hole of the insert part is a long hole in which a length in a width direction of the band is longer than a length in a longitudinal direction of the band when the band is viewed from a plan view.

4. The band according to claim 2, wherein,
the insert part includes a main body and a connector, and
the main body is a part that is longer in a width direction of the band than in a longitudinal direction of the band.

5. The band according to claim 3, wherein,
the insert part includes a main body and a connector, and
the main body is a part that is longer in the width direction of the band than in the longitudinal direction of the band.

6. The band according to claim 2, wherein the first hole of the insert part is a long hole in which a length in a longitudinal direction of the band is longer than a length in a width direction of the band when the band is viewed from a plan view.

7. The band according to claim 6, wherein,
the insert part includes a main body and a connector, and
the main body is a part that is longer in a width direction of the band than in a longitudinal direction of the band.

8. The band according to claim 7, wherein,
a second hole is formed in the insert part when the band is viewed from a side, and
the second hole is penetrated in the width direction of the main body.

9. The band according to claim 7, wherein,
a second hole is formed in the insert part when the band is viewed from a side, and
the second hole is penetrated in the width direction of the main body.

10. The band according to claim 6, wherein the first hole of the insert part is formed so that a longitudinal direction of the first hole is inclined with respect to the longitudinal direction of the band.

11. The band according to claim 7, wherein the first hole of the insert part is formed so that a longitudinal direction of the first hole is inclined with respect to the longitudinal direction of the band.

12. The band according to claim 8, wherein the first hole of the insert part is formed so that a longitudinal direction of the first hole is inclined with respect to the longitudinal direction of the band.

13. The band according to claim 9, wherein the first hole of the insert part is formed so that a longitudinal direction of the first hole is inclined with respect to the longitudinal direction of the band.

14. The band according to claim 2, wherein,
the insert part includes a lattice-shaped hollow structure, and
the hollow structure includes the first hole in which the resin material of the band main body is filled in insert molding.

15. The band according to claim 14, wherein,
the hollow structure includes the first hole, a second hole, and a third hole in which the resin material of the band main body is filled in insert molding, and
the first hole of the insert part is a plurality of holes that can be viewed when the band is viewed from a plan view.

16. The band according to claim 15, wherein the second hole of the insert part is a plurality of holes that can be viewed when the band is viewed from one side.

17. The band according to claim 16, wherein the third hole of the insert part is a plurality of holes that can be viewed when the band is viewed from the other side perpendicular to the one side.

18. A watch comprising:
the band according to claim 1; and
a main body case.

19. A watch comprising:
the band according to claim 2; and
a main body case.

20. A watch comprising:
the band according to claim 3; and
a main body case.
